(19) United States
(12) Patent Application Publication
(10) Pub. No.: US 2017/0308686 A1
(43) Pub. Date: Oct. 26, 2017

(54) AUTHENTICATION METHOD AND AUTHENTICATION DEVICE

(71) Applicant: FUJITSU LIMITED, Kawasaki-shi (JP)

(72) Inventors: Masayuki Takahara, Yokohama (JP); Tatsushige Inaba, Osaka (JP); Katsuaki Nakamura, Kawasaki (JP)

(73) Assignee: FUJITSU LIMITED, Kawasaki-shi (JP)

(21) Appl. No.: 15/488,887

(22) Filed: Apr. 17, 2017

(30) Foreign Application Priority Data
Apr. 20, 2016 (JP) 2016-084592

(51) Int. Cl. G06F 21/10

(52) U.S. Cl. CPC G06F 21/105

(57) ABSTRACT

A method includes accepting specifying of target software as a target of authentication of a license, determining whether a monitoring target process associated with the target software is activated based on information managing a plurality of activated processes, the monitoring target process being a process that executes installation of the target software, determining whether a specific display area corresponding to the monitoring target process is selected based on a selection state of each of a plurality of display areas each corresponding to each of the plurality of activated processes when it is determined that the monitoring target process is activated, acquiring entered information entered by an entry device when it is determined that the specific display area corresponding to the monitoring target process is selected, and carrying out matching between the entered information and license information that is acquired from a memory and is associated with the target software.

### CROSS-REFERENCE TO RELATED APPLICATION

This application is based upon and claims the benefit of priority of the prior Japanese Patent Application No. 2016-084592, filed on Apr. 20, 2016, the entire contents of which are incorporated herein by reference.

### FIELD

The embodiment discussed herein is related to license authentication of software.

### BACKGROUND

When software is installed on a computer, license authentication to check whether a user who uses this software has right authority may be carried out. For example, if license authentication is carried out based on license information (character string or the like) associated with software, this license authentication may be carried out based on entered license information.

As a related art, there has been proposed a technique in which software that has been installed but is not used is detected and exclusion of the software that is not used is carried out to make the number of purchased licenses of the software appropriate (for example, Japanese Laid-open Patent Publication No. 2005-301465).

Furthermore, there has been proposed a technique for resolving a license violation state of software in a computer terminal (for example, Japanese Laid-open Patent Publication No. 2011-243121). Moreover, there has been proposed a technique for reducing the trouble of work and so forth regarding management of kitting of environments including software of terminals of users in an organization (for example, International Publication Pamphlet No. WO 2015/136643).

### SUMMARY

According to an aspect of the embodiment, a method includes accepting specifying of target software as a target of authentication of a license, determining whether a monitoring target process associated with the target software is activated based on information managing a plurality of activated processes, the monitoring target process being a process that executes installation of the target software, determining whether a specific display area corresponding to the monitoring target process is selected based on a selection state of each of a plurality of display areas each corresponding to each of the plurality of activated processes when it is determined that the monitoring target process is activated, acquiring entered information entered by an entry device when it is determined that the specific display area corresponding to the monitoring target process is selected, carrying out matching between the entered information and license information that is acquired from a memory and is associated with the target software, and carrying out control according to a result of the matching.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one example of an overall configuration of a system of an embodiment;

FIG. 2 is a functional block diagram illustrating one example of a client terminal;

FIG. 3 is a functional block diagram illustrating one example of a management server;

FIG. 4 is a diagram illustrating a screen example displayed on a display;

FIG. 5 is a diagram illustrating another screen example displayed on a display;

FIG. 6 is a diagram illustrating one example of various kinds of information stored in a management server;

FIG. 7 is a diagram illustrating one example of various kinds of information stored in a client terminal;

FIG. 8 is a diagram illustrating one example of a process management table;

FIG. 9 is a flowchart (first flowchart) illustrating one example of processing of a management server;

FIG. 10 is a flowchart (second flowchart) illustrating one example of processing of a management server;

FIG. 11 is a flowchart (first flowchart) illustrating one example of processing of a management agent;

FIG. 12 is a flowchart (second flowchart) illustrating one example of processing of a management agent;

FIG. 13 is a flowchart (third flowchart) illustrating one example of processing of a management agent;

FIG. 14 is a diagram (first diagram) illustrating an example of matching by a matching unit;

FIG. 15 is a diagram (second diagram) illustrating an example of matching by a matching unit;

FIG. 16 is a diagram (third diagram) illustrating an example of matching by a matching unit;

FIG. 17 is a flowchart (fourth flowchart) illustrating one example of processing of a management agent;

FIG. 18 is a diagram (fourth diagram) illustrating an example of matching by a matching unit;

FIG. 19 is a diagram (fifth diagram) illustrating an example of matching by a matching unit;

FIG. 20 is a flowchart (first flowchart) illustrating one example of processing of a management agent in a modification example;

FIG. 21 is a flowchart (second flowchart) illustrating one example of processing of a management agent in a modification example; and

FIG. 22 is a diagram illustrating one example of a hardware configuration of a client terminal.

### DESCRIPTION OF EMBODIMENT

If license authentication is carried out based on entered license information, a computer may identify the license information entered for the license authentication and carry out the license authentication based on the identified license information.

When license authentication is carried out, various kinds of entries other than license information may have been made to a computer. In this case, it may be difficult to identify the license information entered for the license authentication among the various kinds of entries to the computer.

If all entries to the computer are analyzed to identify entered license information among the entries and authentication based on this license information is carried out, the amount of processing for identifying the license information may become large and the load of the authentication processing may become high.

As one aspect, the embodiment discussed herein intends to alleviate the load of authentication processing.

<One Example of Overall Configuration of System of Embodiment>

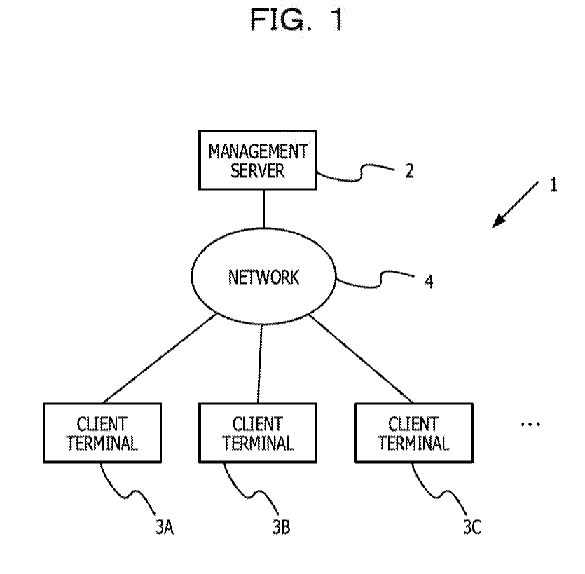

The embodiment will be described below with reference to the drawings. FIG. 1 illustrates one example of the overall configuration of a system 1 of the embodiment. In the system 1, a management server 2 is coupled to plural client terminals 3A, 3B, 3C, . . . (hereinafter, often referred to as the client terminal 3 generically) with the intermediary of a network 4.

The management server 2 is a server that distributes software to the respective client terminals 3 and manages software installed on the respective client terminals 3. For example, on the management server 2, a program that manages software (often referred to as asset) installed on the respective client terminals 3 is installed.

Hereinafter, the program installed on the management server 2 will be often referred to as asset management middleware. This program is not limited to the middleware. For example, this program may be an application program.

The client terminal 3 is one example of a computer. On the client terminal 3, software managed by the asset management middleware of the management server 2 is installed. In the client terminal 3, an authentication program that cooperates with the asset management middleware operates. License authentication when software is installed is carried out by this authentication program.

The network 4 is a network that couples the management server 2 to each client terminal 3. The network 4 is an intra-company network, for example. However, the network 4 is not limited to the intra-company network.

The authentication program (hereinafter, often referred to also as asset management agent or management agent) that operates on each client terminal 3 is controlled by the asset management middleware that operates on the management server 2. For each client terminal 3, installation of only software permitted by the asset management middleware is allowed.

<One Example of Client Terminal>

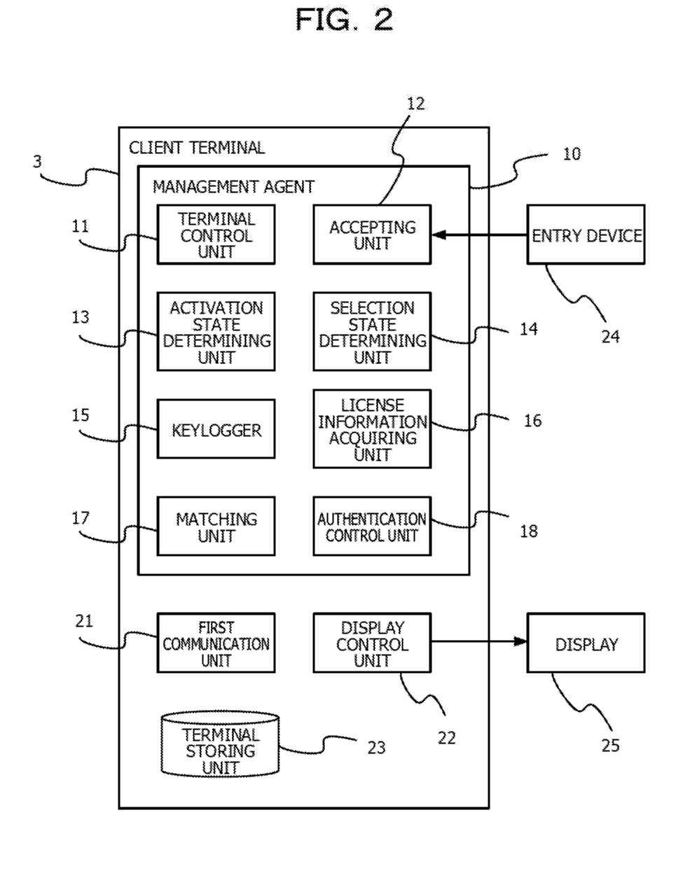

Next, one example of the client terminal 3 will be described. FIG. 2 illustrates one example of the client terminal 3. The client terminal 3 includes a management agent 10, a first communication unit 21, a display control unit 22, and a terminal storing unit 23.

An entry device 24 and a display 25 are coupled to the client terminal 3. The client terminal 3 may include functions of the entry device 24 and the display 25. Furthermore, functions of the entry device 24 and the display 25 may be implemented by a touch panel display.

The management agent 10 is the above-described asset management agent. The first communication unit 21 carries out communications with the management server 2 through the network 4. The display control unit 22 carries out display control of the display 25. The terminal storing unit 23 stores various pieces of information. The terminal storing unit 23 is one example of a storing unit.

The management agent 10 includes a terminal control unit 11, an accepting unit 12, an activation state determining unit 13, a selection state determining unit 14, keylogger 15, a license information acquiring unit 16, a matching unit 17, and an authentication control unit 18.

The terminal control unit 11 carries out various kinds of control in the management agent 10. The accepting unit 12 accepts entries from the entry device 24.

The activation state determining unit 13 determines whether or not a monitoring target process is currently activated. The activation state determining unit 13 is one example of a first determining unit. Suppose that plural processes are activated in an operating system (OS) of the client terminal 3.

The monitoring target process is one example of a process that carries out installation of software about which specifying as a target of license authentication has been accepted. The activation state determining unit 13 determines whether or not the monitoring target process among plural processes that are operating on the OS is currently activated.

If it is determined that the monitoring target process is currently activated, the selection state determining unit 14 determines whether or not a window corresponding to this monitoring target process is currently selected. The window (this window will be often referred to also as screen) displayed on the display 25 is one example of a display area. The selection state determining unit 14 is one example of a second determining unit.

For example, if plural windows are displayed on the display 25, when any one window is selected, this window becomes active. The other windows as one or more windows that are not selected become inactive.

The keylogger 15 acquires entered information entered from the entry device 24. The keylogger 15 is one example of a first acquiring unit. The entry device 24 may be a keyboard, a mouse, or the like. If the window corresponding to the monitoring target process is active, the keylogger 15 of the embodiment acquires entered information entered from the entry device 24 to this window.

For example, if the entry device 24 is a keyboard, the keylogger 15 acquires plural characters (for example, characters each corresponding to one key of the keyboard) entered one character by one character from the keyboard to the active window corresponding to the monitoring target process as character information.

Furthermore, if operation of pasting character information stored in a clipboard is carried out by the entry device 24, the accepting unit 12 accepts this operation and the keylogger 15 acquires the pasted character information.

The clipboard is one example of a given storage area. For example, the clipboard may be a partial area in a random access memory (RAM). In the above case, character information including plural characters is stored in the clipboard.

If it is determined that the monitoring target process is currently activated, the license information acquiring unit 16 acquires, from the terminal storing unit 23, license information associated with the software about which specifying as the target of license authentication has been accepted. The license information acquiring unit 16 is one example of a second acquiring unit.

The matching unit 17 carries out matching between the entered information acquired by the keylogger 15 and the license information acquired by the license information acquiring unit 16. The authentication control unit 18 carries out control based on the matching result of the matching unit 17.

For example, if the entered information and the license information correspond with each other as the result of the matching between both by the matching unit 17, the authentication control unit 18 deems that the license authentication of the software has succeeded, and carries out control according to this success in the authentication.

In the embodiment, even if the entered information and the license information do not all correspond with each other, the authentication control unit 18 deems that the license authentication of the software has succeeded and carries out control according to this success in the authentication in some cases.

<One Example of Management Server>

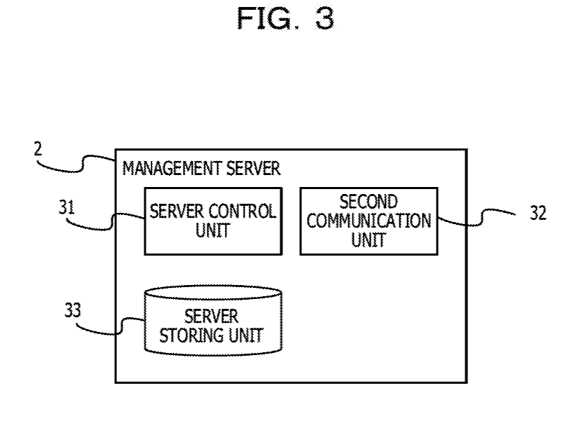

Next, one example of the management server 2 will be described. FIG. 3 illustrates one example of the management server 2. The management server 2 includes a server control unit 31, a second communication unit 32, and a server storing unit 33. The server control unit 31 carries out various kinds of control in the management server 2.

For example, the server control unit 31 carries out distribution control of software to the given client terminal 3. The second communication unit 32 carries out communications with each client terminal 3. For example, the second communication unit 32 transmits software (for example, binary data) to the given client terminal 3 through the network 4. Distribution of the software is thereby carried out. The server storing unit 33 stores various pieces of information.

<Screen Example Displayed on Display>

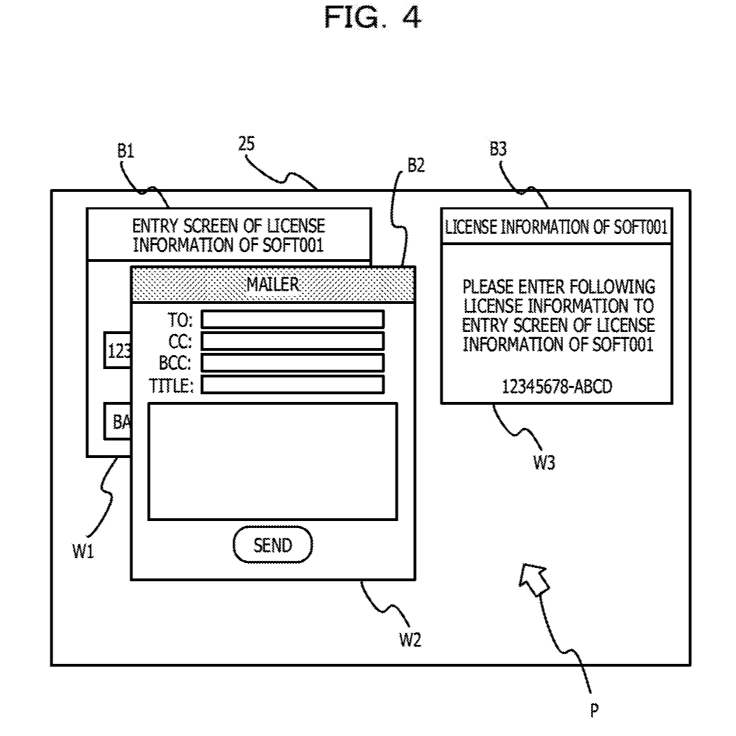

Next, a screen example displayed on the display 25 will be described. FIG. 4 illustrates the screen example displayed on the display 25.

In the example of FIG. 4, three windows W1, W2, and W3 (hereinafter, often referred to as the window W generically) are displayed on the display 25. The number of windows W displayed on the display 25 is not limited to three.

One process corresponds to one window W. In the example of FIG. 4, the window W1 is a window to which license information of software (SOFT001) that is a target of license authentication is entered.

For example, when an operator who operates the client terminal 3 (hereinafter, referred to as user) operates the entry device 24 to carry out installation operation of the software (SOFT001), the accepting unit 12 accepts this installation operation. The accepting unit 12 thereby accepts specifying of the software (SOFT001) of the target of license authentication.

When the accepting unit 12 accepts this specifying, the display control unit 22 carries out control to display the window W1 that requests the entry of the license information of the software (SOFT001) on the display 25. The above-described window W1 is thereby displayed on the display 25.

The window W2 is a window of a mailer to transmit and receive electronic mail. The window W3 is a window that displays the license information of the software (SOFT001) as the target of license authentication.

Each window W includes a bar B (B1, B2, and B3). When the user who operates the client terminal 3 carries out operation of a mouse as the entry device 24, the accepting unit 12 accepts this operation.

This moves the position of a mouse pointer P displayed on the display 25. When dick operation of the mouse is carried out in the state in which the mouse pointer P is located on the bar B of any window W, the accepting unit 12 accepts this operation.

The window W is thereby selected. When the window W is selected, the selection state of this window W becomes the active state. On the other hand, the other windows W, which are not selected, become inactive.

In the example of FIG. 4, the selection state of the window W2 of the mailer is the active state and the selection state of the windows W1 and W3 is the inactive state. In the example of FIG. 4, the bar B2 of the window W2 set active is hatched.

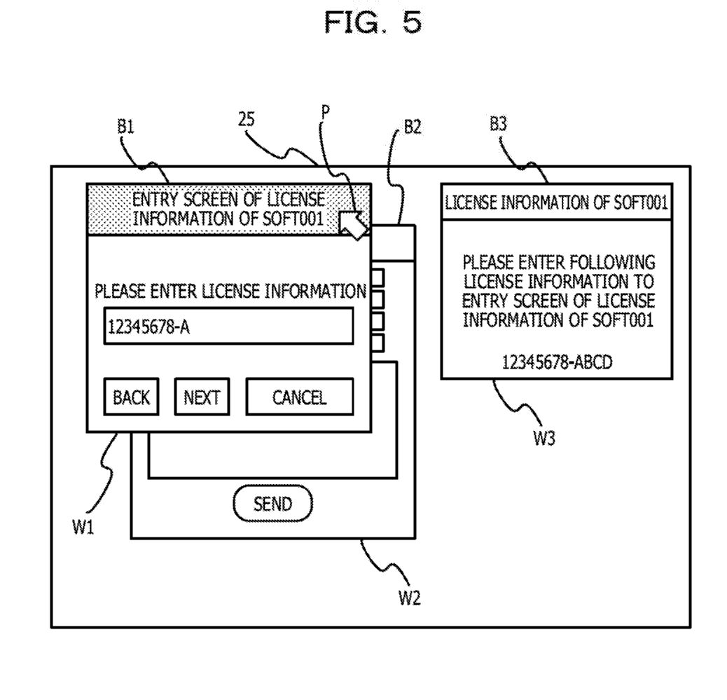

FIG. 5 illustrates one example of the case in which the window to which the license information of the software as the target of license authentication is entered is selected. In this case, the selection state of the window W1 becomes the active state.

In the example of FIG. 5, an item corresponding to an indication of “PLEASE ENTER LICENSE INFORMATION” in the window W1 is an item for entering the license information. Because the selection state of the window W1 is in the active state, the entry of information to the above-described item in the window W1 is valid.

In the display 25, the window W3 that represents the license information of the software (SOFT001) as the target of license authentication is displayed. The user who operates the client terminal 3 enters the license information of the software “SOFT001” based on the display of the window W3.

The accepting unit 12 accepts this entry of the license information. The example of FIG. 5 represents the state in which characters of “12345678-A” in the license information have been entered. In the example of FIG. 5, the bar B1 of the window W1 is hatched in order to indicate that the selection state of the window W1 is the active state.

<One Example of Various Kinds of Information Stored by Management Server>

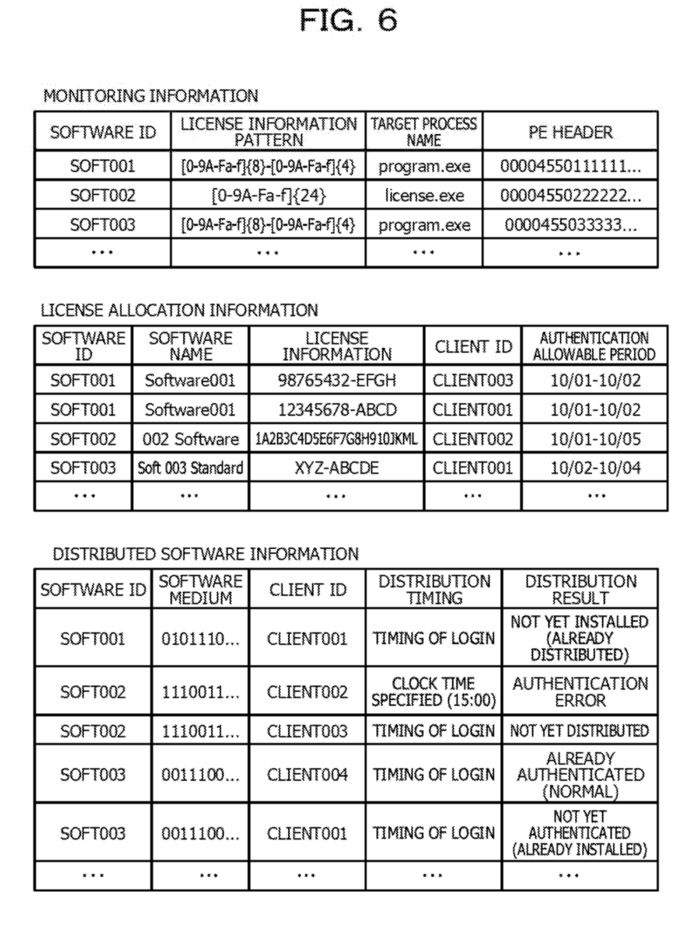

FIG. 6 illustrates various kinds of information stored in the server storing unit 33 of the management server 2. In the server storing unit 33, monitoring information, license allocation information, and distributed software information are stored.

The monitoring information is a table including items of software identification (ID), license information pattern, target process name, and portable executable (PE) header. The software ID is an ID to uniquely identify software.

The license information pattern represents the pattern of license information about each piece of software. For example, in the example of FIG. 6, “[0-9A-Fa-f]{8}-[0-9A-Fa-f]{4}” represents a pattern obtained by lining up a character string of eight characters using “0-9,” “A-F,” or “a-f,” and “-,” and a character string of four characters using “0-9,” “A-F,” or “a-f.”

The target process name represents the name of the monitoring target process. The PE header represents header information of the executable file (EXE File) of the monitoring target process. For example, in the example of FIG. 6, software IDs “SOFT001” and “SOFT003” represent different pieces of software but the target process names of both are the same.

On the other hand, the values of the PE header of both of the software IDs “SOFT001” and “SOFT003” are different. By combining the target process name and the PE header, one software ID is identified.

The target process name is one example of identification information of the monitoring target process. Furthermore, the PE header is one example of another piece of identification information of the monitoring target.

The monitoring information may be embedded in the above-described asset management middleware in advance, for example. In this case, the monitoring information may be stored in the server storing unit 33 through installation of the asset management middleware on the management server 2.

The license allocation information is a table including items of software ID, software name, license information, client ID, and authentication allowable period. The software name represents the name of software.

The license information is information used for license authentication of software indicated by the software ID. The client ID is an ID to identify the client terminal 3. If the same software is installed on different client terminals 3, the license information used for license authentication differs.

For example, if software identified based on the software ID “SOFT001” is distributed to two client terminals 3 individually identified by client IDs “CLIENT001” and “CLIENT003,” pieces of license information are different.

The authentication allowable period is a period in which license authentication is permitted. The license allocation information may be input to the management server 2 by an operator who operates the management server 2 (hereinafter, referred to as administrator), for example. The management server 2 may store the license allocation information in the server storing unit 33 by accepting input relating to the license allocation information.

The distributed software information is a table including items of software ID, software medium, client ID, distribution timing, and distribution result. The software medium is the entity of software (for example, binary data).

The entity of software may be stored in a different area of the server storing unit 33. In this case, information (for example, file name) to identify the area in the server storing unit 33 in which the entity of software is stored, or the like, may be stored in the item of the software medium.

The distribution timing indicates the timing at which the management server 2 distributes software to the client terminal 3.

For example, if the distribution timing indicates “TIMING OF LOGIN,” in response to recognition, by the management server 2, of that login processing has been executed to the client terminal 3 identified based on the client ID, this management server 2 may distribute software to this client terminal 3.

Furthermore, if the distribution timing indicates a specified cock time (in the case of the example of FIG. 6, “CLOCK TIME SPECIFIED (15:00)”), the management server 2 may distribute software to the client terminal 3 at the specified clock time.

The client terminal 3 as the destination of the distribution of software is identified based on the client ID. The distribution result represents the result of the distribution of software to the client terminal 3 by the management server 2.

For example, in the case of the example of FIG. 6, if the distribution result represents “NOT YET INSTALLED (ALREADY DISTRIBUTED),” this indicates that software has been distributed from the management server 2 to the client terminal 3 and the distributed software has not been installed to the management server 2.

If the distribution result represents “AUTHENTICATION ERROR,” this indicates that license authentication of software has failed. If the distribution result represents “NOT YET DISTRIBUTED,” this indicates that software has not been distributed to the client terminal 3 identified based on the client ID.

If the distribution result represents “ALREADY AUTHENTICATED (NORMAL),” this indicates that license authentication of software has succeeded. If the distribution result represents “NOT YET AUTHENTICATED (ALREADY INSTALLED),” this indicates that software has been installed on the client terminal 3 and license authentication has not been carried out.

In this case, because the license authentication of the software has not been carried out, the use of the software installed on the client terminal 3 is limited. After the license authentication succeeds, the limitation of use of the installed software is released.

The client terminal 3 transmits the distribution result like that represented in the above example to the management server 2. The items other than the distribution result in the distributed software information may be input to the management server 2 by the administrator. The management server 2 may store the distributed software information in the server storing unit 33 by accepting input relating to the distributed software information.

The monitoring information, the license allocation information, and the distributed software information each include the software ID. Therefore, the monitoring information, the license allocation information, and the distributed software information are associated with each other based on the software ID.

<One Example of Various Kinds of Information Stored by Client Terminal>

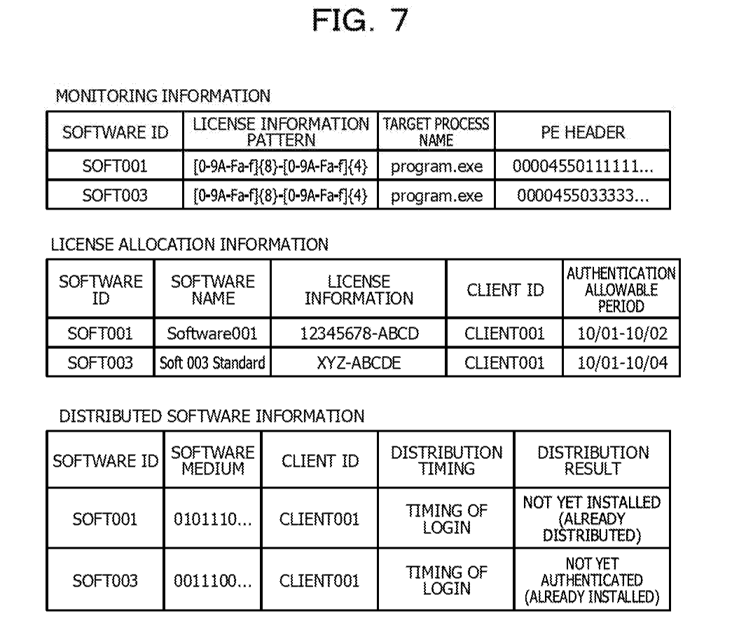

FIG. 7 illustrates one example of various kinds of information stored by the terminal storing unit 23 of the client terminal 3 identified based on the client ID “CLIENT001.” As illustrated in the example of FIG. 7, the monitoring information, the license allocation information, and the distributed software information are stored in the terminal storing unit 23.

These respective pieces of information are information relating to pieces of software distributed to the client terminal 3 identified based on the client ID “CLIENT001” in the respective pieces of information stored in the server storing unit 33 of the management server 2. The above-described respective kinds of information are stored also in the terminal storing units 23 of other client terminals 3.

In the case of the example of FIG. 7, two pieces of software individually identified based on the software IDs “SOFT001” and “SOFT003” are distributed to the client terminal 3 identified based on the client ID “CLIENT001.” The distributed pieces of software are stored in the terminal storing unit 23.

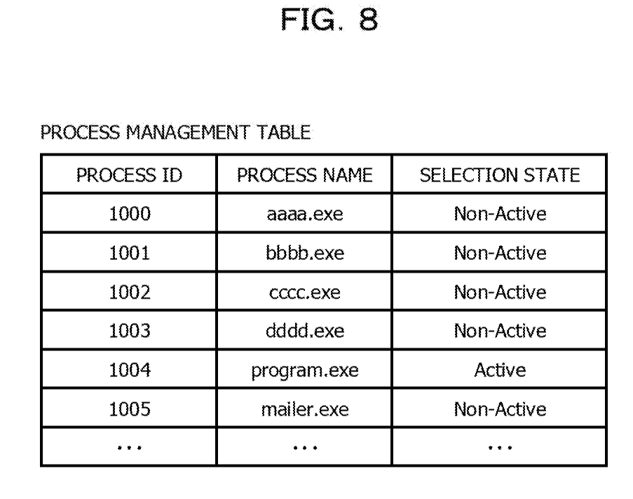

FIG. 8 illustrates one example of a process management table. Plural processes operate on the OS executed in the client terminal 3. The terminal control unit 11 manages each process that is operating on the OS by the process management table. The process management table may be stored in the terminal storing unit 23.

The process management table is a table including items of process ID, process name, and selection state. The process ID is an ID to identify the process. The process name is the name of the process.

The selection state indicates whether or not the corresponding window is active (currently selected) regarding each process as described above. The process whose corresponding window is active represents “Active” and the process whose corresponding window is not currently selected represents “Non-Active.” In the case of the example of FIG. 8, the process management table indicates that the window corresponding to a process name “program.exe” is currently selected.

<Flowchart that Illustrates One Example of Flow of Processing of Management Server>

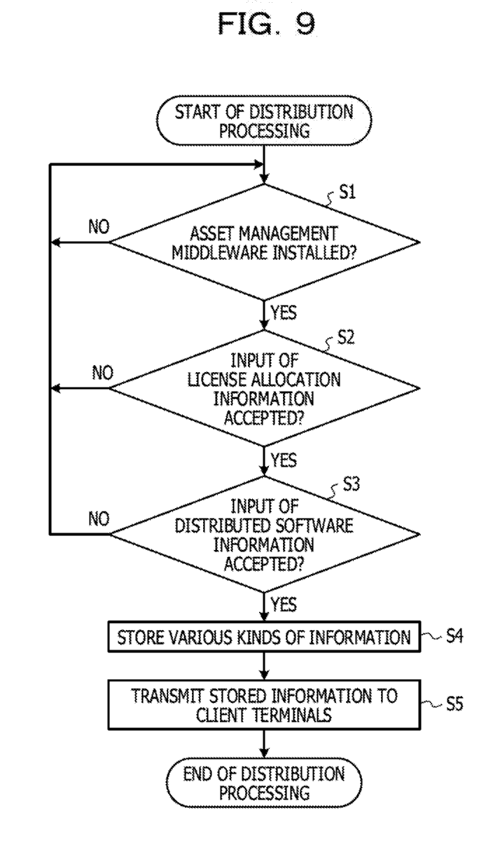

FIG. 9 illustrates one example of the flow of processing of distribution of the monitoring information, the license allocation information, and the distributed software information to the client terminal 3 by the management server 2. The server control unit 31 determines whether or not asset management middleware has been installed (step S1).

For example, when the administrator carries out operation of installing the asset management middleware on the management server 2, the management server 2 accepts this operation. By the acceptance of this operation by the management server 2, the asset management middleware is installed on the management server 2.

In the case of YES in the step S1, the server control unit 31 determines whether or not input of the license allocation information has been accepted (step S2). In the case of YES in the step S2, the server control unit 31 determines whether or not input of the distributed software information has been accepted (step S3).

For example, when the administrator inputs the license allocation information and the distributed software information to the management server 2, this management server 2 may accept the input license allocation information and distributed software information and store these pieces of information in the server storing unit 33. In the case of NO in the step S1, the step S2, or the step S3, the processing returns to the step S1.

In the case of YES in the step S3, the server control unit 31 stores various kinds of information in the server storing unit 33 (step S4). Due to the installation of the asset management middleware, the monitoring information is stored in the server storing unit 33.

Due to the acceptance of input of information relating to the license allocation information by the management server 2, the license allocation information is stored in the server storing unit 33. Due to the acceptance of input of information relating to the distributed software information by the management server 2, the distributed software information is stored in the server storing unit 33.

Based on the license allocation information, the server control unit 31 transmits the various kinds of information that are stored (monitoring information, license allocation information, and distributed software information) to each client terminal 3 identified based on the client ID (step S5). The distributed software information includes the entities of pieces of software. Due to this, the pieces of software are distributed to the client terminals 3.

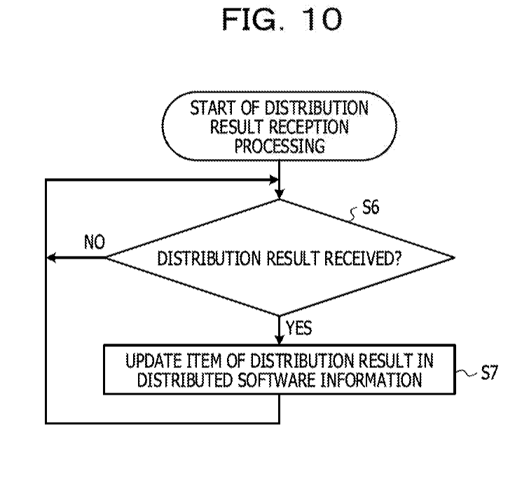

FIG. 10 illustrates one example of the flow of processing of reception of the distribution result by the management server 2. In the above-described step S5, the client terminal 3 receives the various kinds of information (monitoring information, license allocation information, and distributed software information) from the management server 2.

The client terminal 3 carries out installation and license authentication of the distributed software based on the various kinds of information that are received. The terminal control unit 11 carries out control to transmit the distribution result that indicates the result of the processing to the management server 2.

Based on this control, the first communication unit 21 transmits the distribution result to the management server 2. In this distribution result, the client ID and the software ID are included.

The management server 2 determines whether or not the distribution result has been received from the client terminal 3 (step S6). In the case of NO in the step S6, the processing does not proceed to the next step.

In the case of YES in the step S6, the server control unit 31 updates information on the item of the distribution result in the distributed software information stored in the server storing unit 33 based on information on the received distribution result (step S7).

As described above, the client ID and the software ID are included in the distribution result received from the client terminal 3. The server control unit 31 updates information on the item of the distribution result corresponding to the client ID and the software ID included in the received distribution result.

<Flowchart that Indicates One Example of Flow of Processing of Management Agent>

Next, the flow of processing of the management agent will be described. Suppose that, in the embodiment, when software distributed from the management server 2 is installed on the client terminal 3, license authentication of this software is carried out.

In the following, suppose that the client ID to identify the client terminal 3 is “CLIENT001.” As described above, the management server 2 transmits various kinds of information (monitoring information, license allocation information, and distributed software information) to the client terminal 3 based on information on the item of the distribution timing in the distributed software information stored in the server storing unit 33.

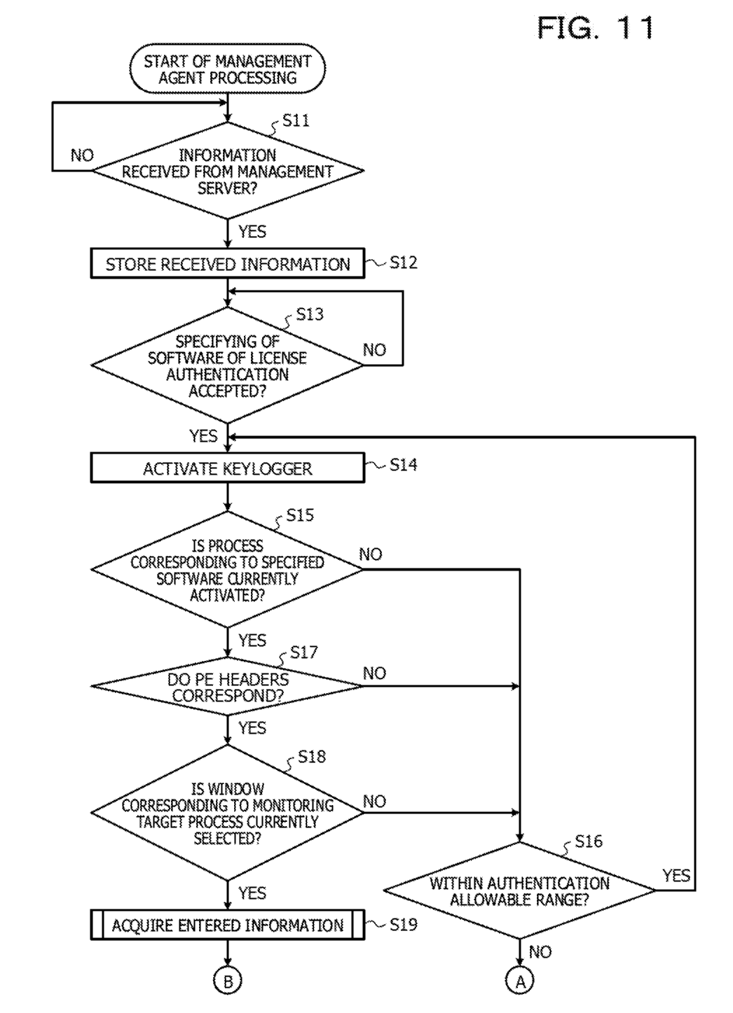

As illustrated in the example of FIG. 11, the management agent 10 determines whether or not the client terminal 3 has received the above-described various kinds of information from the management server 2 (step S11).

In the case of NO in the step S11, the processing does not proceed to the next step. In the case of YES in the step S11, the terminal control unit 11 stores the monitoring information, the license allocation information, and the distributed software information that are received in the terminal storing unit 23 (step S12).

The terminal control unit 11 determines whether or not the accepting unit 12 has accepted specifying of software that is a target of license authentication (step S13). For example, the user carries out operation of executing an installation program (hereinafter, often referred to as installer) that carries out installation of software by using the entry device 24.

When the accepting unit 12 accepts this operation, the terminal control unit 11 may determine that specifying of software of license authentication has been accepted. In the following, suppose that the accepting unit 12 has accepted specifying of software whose software ID is “SOFT001.”

In the case of NO in the step S13, the processing does not proceed to the next step. In the case of YES in the step S13, the terminal control unit 11 activates the keylogger 15 (step S14). Then, the terminal control unit 11 determines whether or not the monitoring target process corresponding to the specified software is currently activated (step S15).

If installation of the specified software is executed, a process for carrying out the installation of the software operates on the OS. This process is the monitoring target process. For example, when the above-described installer is executed, the monitoring target process is activated on the OS.

The activation state determining unit 13 refers to the monitoring information and the process management table stored in the terminal storing unit 23 and determines whether or not the monitoring target process associated with the specified software is currently activated.

In the monitoring information, the software ID to identify software and the monitoring target process name are associated. In the process management table, the process ID and process name of the process that is currently activated are associated.

For example, as described above, the software ID of the software as the target of the license authentication is “SOFT001.” In the example of FIG. 7, in the monitoring information stored in the terminal storing unit 23, the monitoring target process name corresponding to the software ID “SOFT001” is “program.exe.”

The activation state determining unit 13 refers to the item of the process name in the process management table stored in the terminal storing unit 23 and determines whether the monitoring target process name “program.exe” is included.

In the example of FIG. 8, in the process management table, a process ID “1004” and a process name “program.exe” correspond to each other. This process name is the above-described monitoring target process name. Therefore, the activation state determining unit 13 determines that the monitoring target process associated with the specified software is currently activated (YES in the step S15).

On the other hand, if the monitoring target process name “program.exe” is not included in the process management table (NO in the step S15), the activation state determining unit 13 determines that the monitoring target process associated with the specified software is not currently activated.

In the case of NO in the step S15, the terminal control unit 11 refers to the license allocation information stored in the terminal storing unit 23 and determines whether or not the authentication period specified for the license authentication of the specified software is within the authentication allowable range (step S16).

In the license allocation information, information on the item of the authentication allowable period corresponding to the software ID “SOFT001” of the software as the target of the license authentication represents “October 1-October 2.”

If the present date is within the range of “October 1-October 2,” the terminal control unit 11 determines that the authentication period specified for the license authentication of the specified software is within the authentication allowable range (YES in the step S16). In this case, the processing returns to the step S15.

On the other hand, if the present date is outside the range of “October 1-October 2” (NO in the step S16), the terminal control unit 11 determines that the authentication period specified for the license authentication of the specified software is outside the authentication allowable range. In this case, the license authentication fails. In the case of NO in the step S16, the processing proceeds to “A.”

There is a possibility that a process with the same name as the monitoring target process name is operating on the OS of the client terminal 3. In this case, there is a possibility that the determination of the step S15 results in YES based on the process other than the monitoring target process (process with the same name as the monitoring target process name).

Therefore, the activation state determining unit 13 refers to the monitoring information stored in the terminal storing unit 23 and recognizes the PE header corresponding to the software ID of the software as the target of the license authentication.

Furthermore, with reference to the process management table, the activation state determining unit 13 recognizes the process name corresponding to the software ID of the software as the target of the license authentication and checks the PE header of the process identified based on this process name.

For example, the activation state determining unit 13 may analyze the process of the check target and check the PE header included in this process. The activation state determining unit 13 determines whether or not the checked PE header and the PE header recognized based on the monitoring information correspond with each other (step S17).

In the case of NO in the step S17, the PE headers of both do not correspond with each other and thus it is determined that the process of the recognized process name is not the monitoring target process. In this case, the processing proceeds to the step S16.

In the case of YES in the step S17, the activation state determining unit 13 determines that the monitoring target process as the target of license authentication of software is currently activated. Because the activation state determining unit 13 determines whether the monitoring target process is currently activated based on two kinds of information, the process name and the PE header, the accuracy of the determination of whether or not the monitoring target process is currently activated is improved.

In the case of YES in the step S17, the selection state determining unit 14 determines whether or not the window W corresponding to the monitoring target process of the software as the target of the license authentication is active (currently selected) (step S18).

The selection state determining unit 14 refers to the process management table stored in the terminal storing unit 23 and determines whether or not the selection state corresponding to the monitoring target process name is “Active.” In the case of YES in the step S18, it is determined that the window W corresponding to the monitoring target process of the software as the target of the license authentication is active (currently selected).

In this case, the keylogger 15 executes processing of acquiring entered information accepted from the entry device 24 by the accepting unit 12 (step S19). Upon the end of the processing of the step S19, the processing proceeds to “B.”

On the other hand, in the case of NO in the step S18, it is determined that the window W corresponding to the monitoring target process of the software as the target of the license authentication is not currently selected (it is determined that the window W is “Non-Active (inactive)”). In this case, the processing proceeds to the step S16.

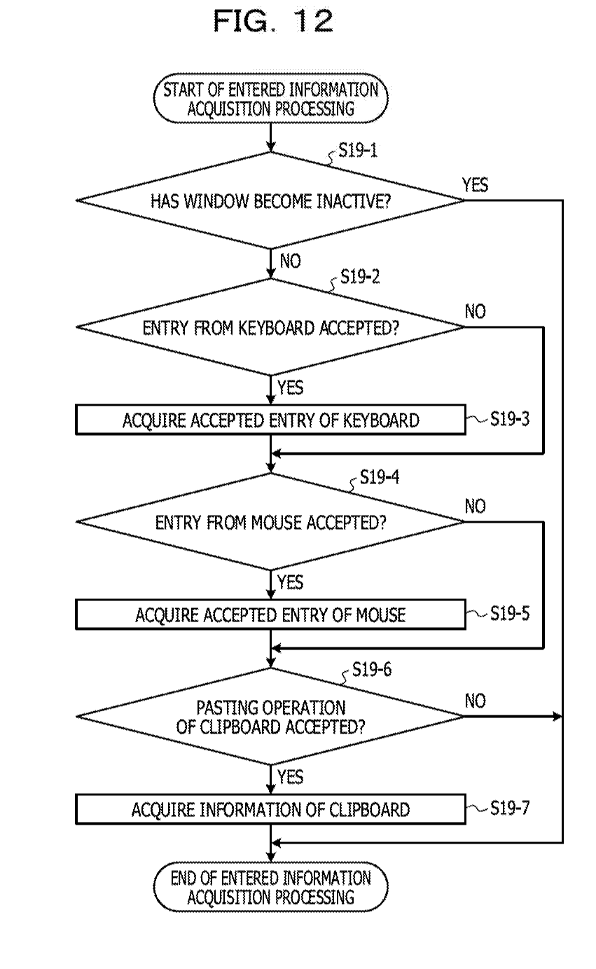

The processing of the step S19 will be described with reference to FIG. 12. The selection state determining unit 14 determines whether the window W corresponding to the monitoring target process of the software as the target of the license authentication has become inactive (step S19-1).

For example, in the step S19-1, the selection state determining unit 14 determines whether the window W corresponding to the monitoring target process of the software as the target of the license authentication has been released from the active state and become inactive.

The selection state determining unit 14 may determine whether the above-described window W has become inactive based on the process management table. In the case of YES in the step S19-1, the processing of acquiring entered information ends.

In the case of NO in the step S19-1, the selection state determining unit 14 determines whether the accepting unit 12 has accepted an entry from a keyboard as the entry device 24 (step S19-2). In the case of YES in the step S19-2, the keylogger 15 acquires the entry of the keyboard accepted by the accepting unit 12 (step S19-3). In the case of NO in the step S19-2, the processing of the step S19-3 is not executed.

The selection state determining unit 14 determines whether the accepting unit 12 has accepted an entry from a mouse as the entry device 24 (step S19-4). In the case of YES in the step S19-4, the keylogger 15 acquires the entry of the mouse accepted by the accepting unit 12 (step S19-5). In the case of NO in the step S19-4, the processing of the step S19-5 is not executed.

The selection state determining unit 14 determines whether the accepting unit 12 has accepted pasting operation of the clipboard from the keyboard or the mouse as the entry device 24 (step S19-6).

In the case of YES in the step S19-6, the keylogger 15 acquires character information temporarily stored in the clipboard (above-described RAM) (step S19-7). In the case of NO in the step S19-6, the processing of the step S19-7 is not executed.

Through the above, the keylogger 15 acquires the entered information. The processing of the step S19 is executed if the monitoring target process corresponding to software about which specifying has been accepted is currently activated and the window corresponding to this monitoring target process is active (currently selected).

Due to this, even when plural entries are made to the client terminal 3, the keylogger 15 acquires entered information to the window that is active and therefore the entered information of the target of the acquisition is narrowed down.

Thus, without processing of analyzing all of the above-described plural entries, entered license information may be identified from the plural entries to the client terminal 3. This may suppress increase in the amount of processing for identifying the entered license information, so that the load of the authentication processing may be alleviated.

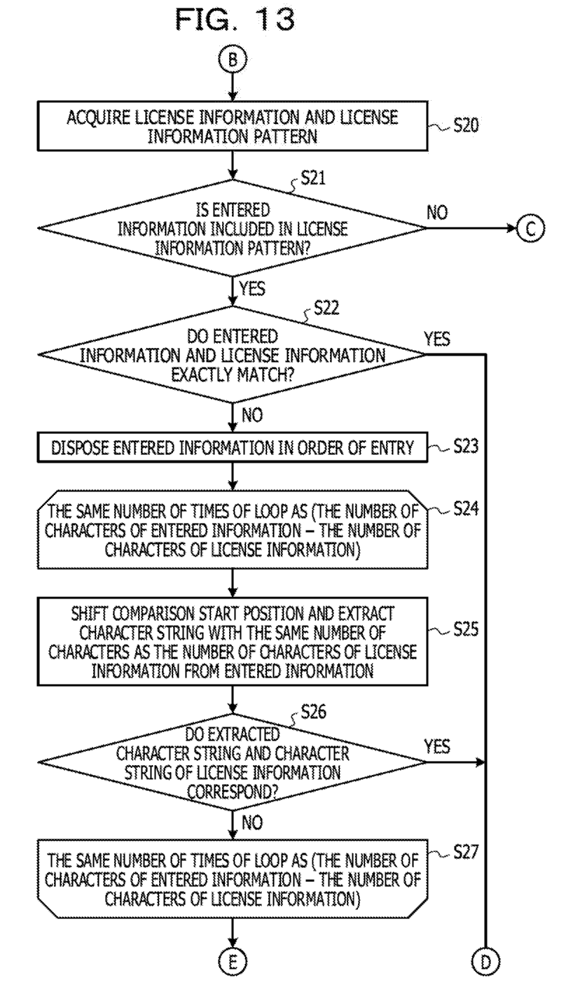

Next, processing subsequent to the step S19 (processing subsequent to “B”) will be described with reference to an example of FIG. 13. The processing subsequent to the step S19 is one example of processing in which the matching unit 17 matches the acquired entered information against license information and the authentication control unit 18 carries out authentication control based on the matching result.

The license information acquiring unit 16 acquires the license information and the license information pattern of the software as the target of the license authentication (step S20).

The software ID to identify the software as the target of the license authentication is “SOFT001.” The license information acquiring unit 16 refers to the monitoring information and recognizes the license information pattern corresponding to this software ID.

Furthermore, the license information acquiring unit 16 refers to the license allocation information and recognizes the license information corresponding to the software ID “SOFT001.” The matching unit 17 determines whether or not the acquired entered information is included in the license information pattern (step S21).

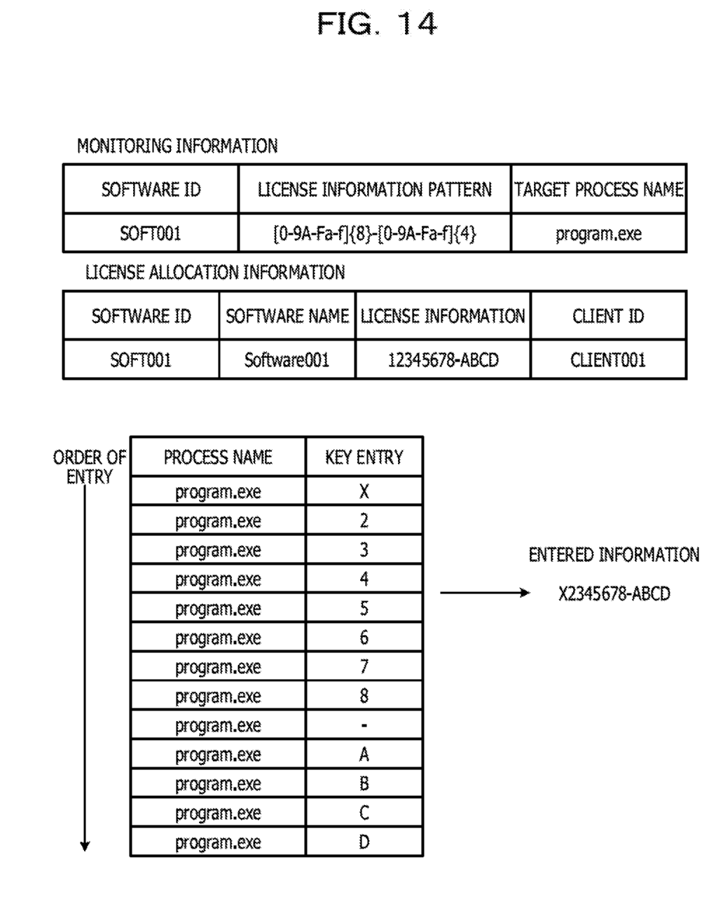

The case in which the acquired entered information is not included in the license information pattern (NO in the step S21) will be described with reference to an example of FIG. 14. As illustrated in the example of FIG. 14, in the monitoring information, the license information pattern corresponding to the software ID “SOFT001” is “[0-9A-Fa-f]{8}-[0-9A-Fa-f]{4}.”

Furthermore, the license information corresponding to the software ID “SOFT001” is “12345678-ABCD.”

On the other hand, the entered information acquired by the keylogger 15 is “X2345678-ABCD.” As illustrated in the example of FIG. 14, this entered information is a character string in which characters that are key-entered (entered from the keyboard as the entry device 24) are lined up in the order of entry.

As described above, the above-described license information pattern indicates that the license information has a pattern obtained by lining up a character string of eight characters using “0-9,” “A-F,” or “a-f,” and “-,” and a character string of four characters using “0-9,” “A-F,” or “a-f.”

“X” in the above-described entered information corresponds to none of “0-9,” “A-F,” and “a-f” represented by the character string of the first eight characters in the license information pattern. Therefore, the entered information “X2345678-ABCD” acquired by the keylogger 15 is not included in the license information pattern corresponding to the software ID “SOFT001.”

In this case, as the result of the matching by the matching unit 17, the entered information acquired by the keylogger 15 is not included in the license information pattern corresponding to the software as the target of the license authentication and therefore the authentication control unit 18 determines that the license authentication has failed. As illustrated in the example of FIG. 13, the processing proceeds to “C” in the case of NO in the step S21.

The authentication control unit 18 may determine that the license authentication has failed only through making of the determination that the entered information is not included in the license information pattern by the matching unit 17. Due to this, failure in the license authentication is determined without detailed matching between the entered information and the license information and therefore the load of the authentication processing may be alleviated.

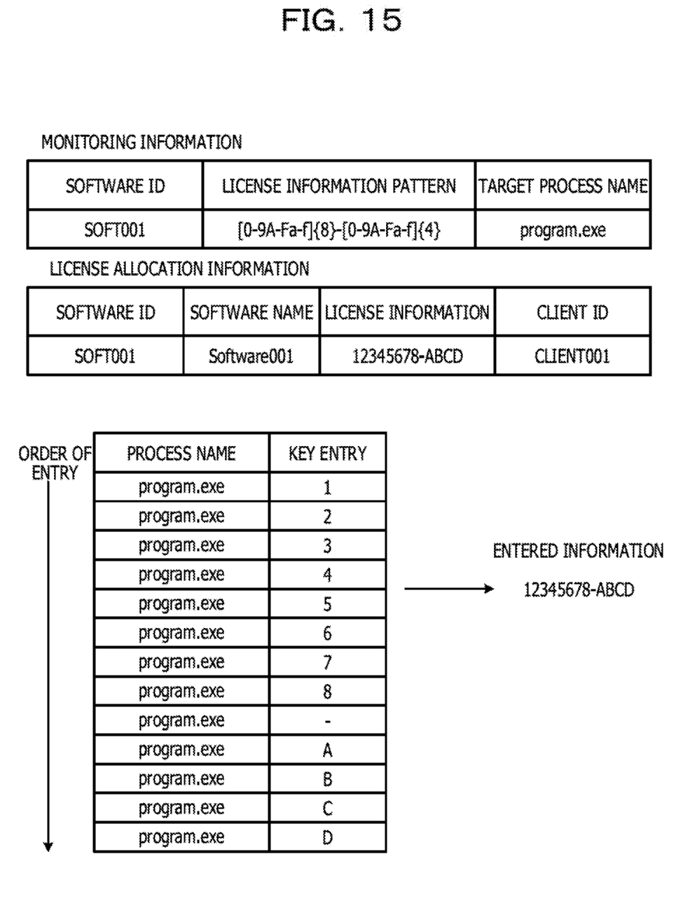

In the example of FIG. 13, in the case of YES in the step S21, the matching unit 17 determines whether or not the acquired entered information and the license information all correspond with each other (step S22). The case in which the acquired entered information and the license information all correspond with each other (YES in the step S22) will be described with reference to an example of FIG. 15.

In the case of the example of FIG. 15, the entered information all corresponds with the license information as the result of the matching by the matching unit 17. In this case, the authentication control unit 18 determines that the license authentication has succeeded. As illustrated in the example of FIG. 13, the processing proceeds to “D” in the case of YES in the step S22.

In the embodiment, even if the acquired entered information and the license information do not all correspond with each other, the authentication control unit 18 determines that the license authentication has succeeded under a given condition.

However, as the result of the matching by the matching unit 17, the authentication control unit 18 may determine whether or not the license authentication has succeeded based only on whether the acquired entered information and the license information all correspond with each other. In this case, only the step S22 is carried out as processing relating to the matching by the matching unit 17.

In the case of NO in the step S22, the matching unit 17 disposes the entered information acquired by the keylogger 15 in the order of entry (step S23). Then, the matching unit 17 executes loop processing of a step S24 to a step S27 the same number of times as the number of characters obtained by subtracting the number of characters of the license information from the number of characters of the entered information.

The matching unit 17 shifts the comparison start position of the entered information and extracts a character string with the same number of characters as the number of characters of the license information from the entered information (step S25). The initial value of the comparison start position is the first character of the entered information disposed in the order of entry.

Then, the matching unit 17 determines whether or not the extracted character string and the character string of the license information correspond with each other (step S26). In the case of YES in the step S26, the authentication control unit 18 determines that the license authentication has succeeded, and the processing proceeds to “D.” On the other hand, in the case of NO in the step S26, the processing of the step S25 and the step S26 is executed again.

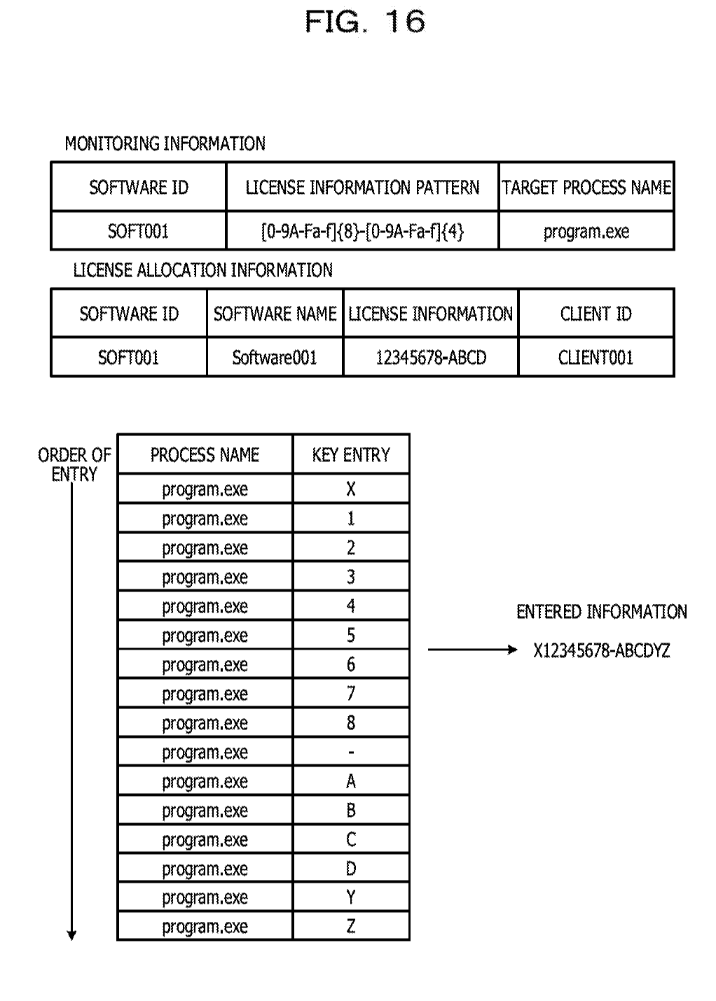

The processing of the step S24 to the step S27 will be described with reference to an example of FIG. 16. In the case of the example of FIG. 16, the entered information is “X12345678-ABCDYZ.” In this entered information, “X12345678” includes a character string “12345678” of eight characters using “0-9,” “A-F,” or “a-f.”

Furthermore, the above-described entered information includes “-.” Moreover, in the above-described entered information, “ABCDYZ” includes a character string “ABCD” of four characters using “0-9,” “A-F,” or “a-f.” Therefore, the entered information of the example of FIG. 16 includes the license information pattern.

Because the entered information is “X12345678-ABCDYZ,” the number of characters of the entered information is “16.” Because the license information is “12345678-ABCD,” the number of characters of the license information is “13.”

Thus, the matching unit 17 repeats the loop processing of the step S24 to the step S27 at most three times (=16−13). The matching unit 17 extracts a character string of thirteen characters (=the number of characters of the license information) from the entered information. This extraction of the character string is carried out based on the comparison start position.

As described above, the initial value of the comparison start position is the first character of the entered information disposed in the order of entry. Therefore, the matching unit 17 extracts a character string of thirteen characters from the first character of the entered information “X12345678-ABCDYZ.”

The extracted character string is “X12345678-ABC.” The matching unit 17 determines whether the extracted character string and the character string of the license information correspond with each other. Because the license information is “12345678-ABCD,” the matching unit 17 determines that the character strings of both do not correspond with each other in this case.

Therefore, the matching unit 17 extracts a character string of thirteen characters from the entered information again. At this time, the matching unit 17 shifts the comparison start position by one character and extracts the character string of thirteen characters from the second character of the entered information, which is a character string of sixteen characters.

The extracted character string is “12345678-ABCD” and therefore the matching unit 17 determines that the extracted character string and the character string of the license information correspond with each other. In this case, the authentication control unit 18 determines that the license authentication has succeeded.

For example, there is the case in which a user who has right authority erroneously enters license information. In this case, the character string of the entered information accepted by the accepting unit 12 does not all correspond with the character string of the license information.

In this case, license authentication in consideration of the erroneous entry of license information is carried out through execution of the loop processing of the step S24 to the step S27.

In the case of the above-described example, the loop processing of the step S24 to the step S27 is repeated at most three times. If the determination of YES is not made in the step S26 even when the loop processing of the step S24 to the step S27 is repeated three times, the processing proceeds to “E.”

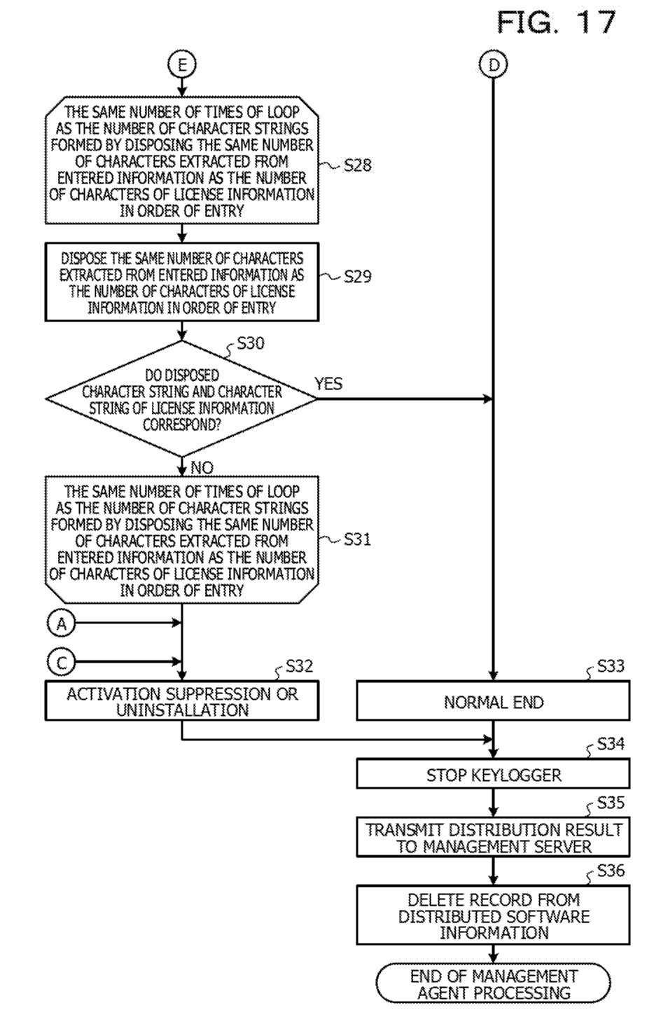

Processing subsequent to “D” and “E” will be described with reference to a flowchart of FIG. 17. The matching unit 17 executes the same number of times of loop processing (step S28 to step S31) as the number of character strings formed by disposing the same number of characters extracted from the entered information as the number of characters of the license information in the order of entry.

The matching unit 17 disposes the same number of characters extracted from the entered information as the number of characters of the license information in the order of entry (in the order of sequence in the character string) (step S29). The matching unit 17 determines whether or not the character string in which the plural characters extracted from the character string of the entered information according to the order of sequence in this character string are sequentially disposed and the character string of the license information correspond with each other (step S30).

In the case of YES in the step S30, the authentication control unit 18 determines that the license authentication has succeeded. In the case of NO in the step S30, the processing of the step S29 and the step S30 is repeated.

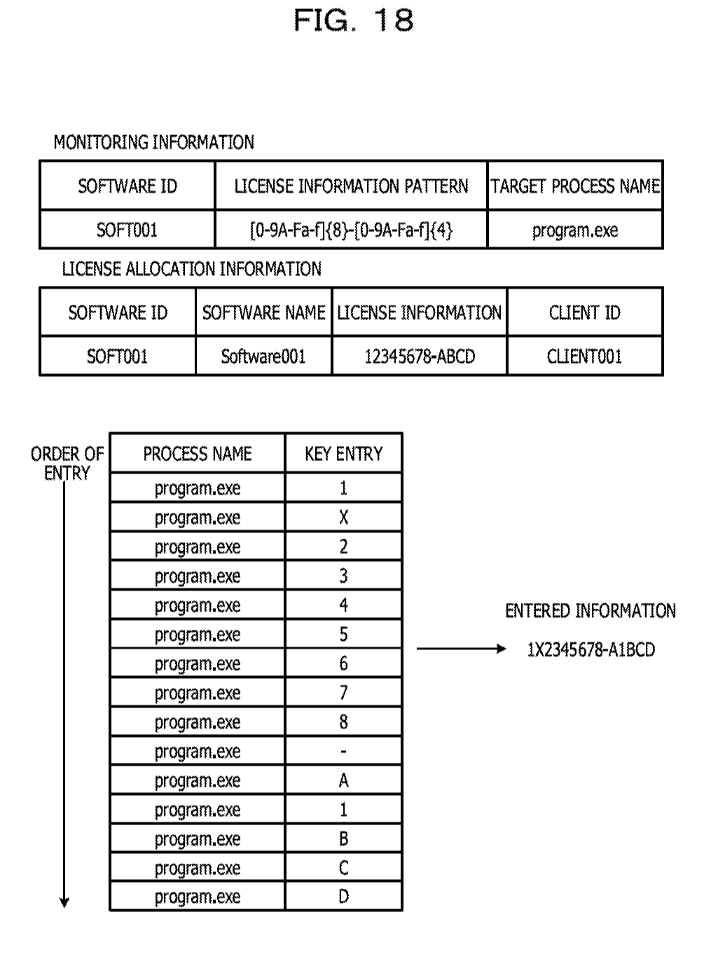

The loop processing of the step S28 to the step S31 will be described with reference to an example of FIG. 18. In the case of the example of FIG. 18, the entered information is “1X2345678-A1BCD.” The number of characters of this entered information is “15.” In this entered information, “1X2345678” includes a character string “12345678” of eight characters using “0-9,” “A-F,” or “a-f.”

Furthermore, the above-described entered information includes “-.” Moreover, in the above-described entered information, “A1BCD” includes a character string “ABCD” of four characters using “0-9,” “A-F,” or “a-f.” Therefore, the entered information of the example of FIG. 18 includes the license information pattern.

The matching unit 17 disposes the same number of characters extracted from the character string of the entered information as the number of characters of the license information (=13) in the order of entry. The matching unit 17 extracts thirteen characters from the entered information “1X2345678-A1BCD” according to the order of entry and disposes the thirteen characters in the order of entry.

For example, if the matching unit 17 extracts thirteen characters with exclusion of the first character and the second character from the entered information “1X2345678-A1BCD” and disposes the extracted thirteen characters in the order of entry, the disposed character string is “2345678-A1BCD.”

In this case, the disposed character string does not correspond with the character string of the license information and therefore the matching unit 17 makes a determination of NO in the step S30.

For example, if the matching unit 17 extracts thirteen characters with exclusion of the first character and the twelfth character from the entered information “1X2345678-A1BCD” and disposes the extracted thirteen characters in the order of entry, the disposed character string is “X2345678-ABCD.”

In this case, the disposed character string does not correspond with the license information and therefore the matching unit 17 makes a determination of NO in the step S30.

For example, if the matching unit 17 extracts thirteen characters with exclusion of the second character and the twelfth character from the entered information “1X2345678-A1BCD” and disposes the extracted thirteen characters in the order of entry, the disposed character string is “12345678-ABCD.”

In this case, the disposed character string corresponds with the license information and therefore the matching unit 17 makes a determination of YES in the step S30.

In the above-described processing of the step S24 to the step S27, the authentication control unit 18 determines that the license authentication has succeeded, even when an erroneous entry in which the character string that all corresponds with the character string of the license information is included and other characters are added to this character string is made.

On the other hand, in the processing of the step S28 to the step S31, the authentication control unit 18 determines that the license authentication has succeeded, even when an erroneous entry in which the character string that all corresponds with the character string of the license information is not included is made.

For example, in the case of the above-described example, even if a character based on an erroneous entry is included in the character string that all corresponds with the character string of the license information, the matching unit 17 makes a determination of YES in the step S30 and the authentication control unit 18 determines that the license authentication has succeeded.

Plural combinations exist as the combination when the character string of thirteen characters (character string of license information) is extracted from the character string of fifteen characters (character string of entered information). Regarding all combinations, the loop processing of the step S28 to the step S31 illustrated in the example of FIG. 17 is executed.

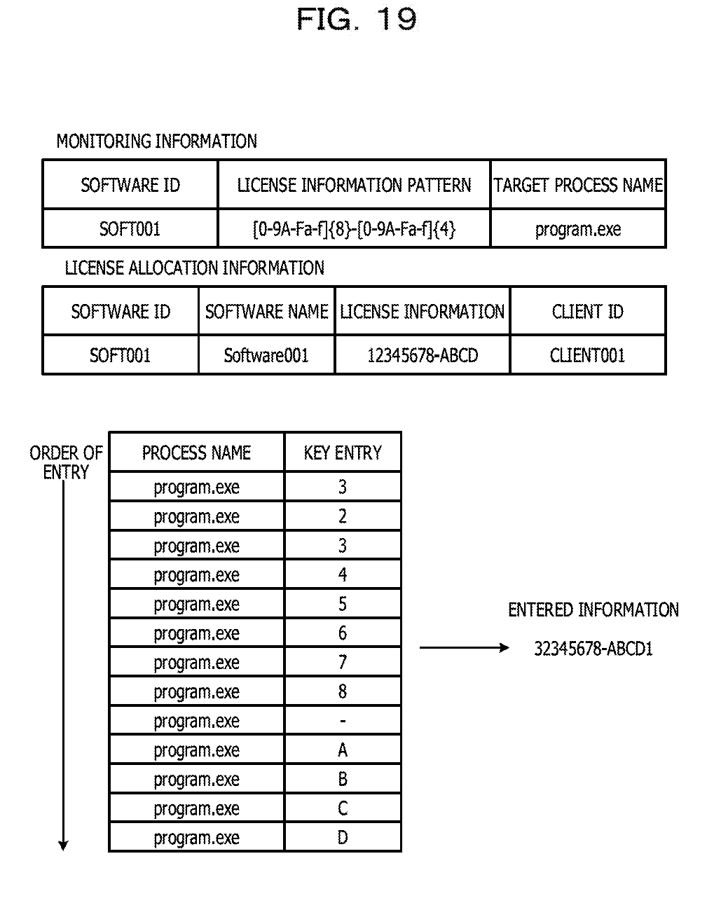

There is the case in which the determination of the step S30 does not result in YES even when the loop processing of the step S28 to the step S31 is executed regarding all combinations. This case will be described with reference to an example of FIG. 19.

In the example of FIG. 19, the entered information is “32345678-ABCD1.” The number of characters of this entered information is “14.” In this entered information, “32345678” includes a character string “32345678” of eight characters using “0-9,” “A-F,” or “a-f.”

Furthermore, the above-described entered information includes “-.” Moreover, in the above-described entered information, “ABCD1” includes a character string “ABCD” of four characters using “0-9,” “A-F,” or “a-f.” Therefore, the entered information of the example of FIG. 19 includes the license information pattern.

On the other hand, even when the same number of characters extracted from the character string “32345678-ABCD1” of the entered information as the number of characters of the license information are disposed in the order of entry, the character string of the above-described entered information does not include the character string “12345678-ABCD” of the license information.

In this case, the determination of the step S30 does not result in YES even when the loop processing of the step S28 to the step S31 illustrated in the example of FIG. 17 is executed regarding all combinations. When the step S30 does not result in YES in the loop processing of the step S28 to the step S31, the authentication control unit 18 determines that the license authentication has failed.

If the authentication control unit 18 determines that the license authentication has failed or it is determined in the step S16 that the specified authentication period is outside the authentication allowable range, the authentication control unit 18 carries out control of activation suppression or uninstallation of the software as the target of the license authentication (step S32). The authentication control unit 18 carries out this control to the OS of the client terminal 3.

If determining that the license authentication has succeeded, the authentication control unit 18 installs the software as the target of the license authentication on the client terminal 3 and normally ends the processing (step S33).

After the processing of the step S32 or the step S33 is executed, the keylogger 15 stops (step S34). Through the above-described respective kinds of processing, the software is distributed from the management server 2 to the client terminal 3. The terminal control unit 11 transmits the distribution result to the management server 2 (step S35).

Furthermore, the terminal control unit 11 deletes the data (record) relating to the software as the target of the license authentication in the above-described respective kinds of processing (step S36). For example, the record in which the distribution result represents “AUTHENTICATION ERROR” or “ALREADY AUTHENTICATED (NORMAL)” in the distributed software information is deleted from the distributed software information.

As described above, if the window corresponding to the monitoring target process corresponding to software about which specifying of license authentication has been accepted is active, the keylogger 15 acquires an entry to the window whose selection state is the active state.

Due to this, the keylogger 15 acquires the entry to the window that is currently selected without processing of analyzing all entries to the client terminal 3 and identifying license information among the entries. Therefore, the load of the authentication processing for carrying out the license authentication may become low.

### Modification Example

Next, a modification example will be described. The modification example is an example of the case in which the OS of the client terminal 3 is rebooted after software that is a target of license authentication is installed on the client terminal 3 and before the license authentication is carried out.

The terminal control unit 11 determines whether or not the OS is rebooted after installation of software that is a target of license authentication on the client terminal 3 is completed and before the license authentication is carried out (step S41).

In the case of NO in the step S41, the processing of the management agent 10 in the modification example ends. In the case of YES in the step S41, the terminal control unit 11 determines whether or not a record exists in the distributed software information stored in the terminal storing unit 23 (step S42).

In the case of NO in the step S42, the processing of the management agent 10 in the modification example ends. In the case of YES in the step S42, the keylogger 15 is activated (step S14).

In the case of YES in the step S41, the record that exists in the distributed software information is only a record in which the distribution result represents “NOT YET AUTHENTICATED (ALREADY INSTALLED).” In the case of YES in the step S41, installation of the software as the target of the license authentication has been completed.

Therefore, a record in which the distribution result represents “NOT YET INSTALLED (ALREADY DISTRIBUTED)” does not exist in the distributed software information. Furthermore, in the case of YES in the step S41, a record in which the distribution result represents “AUTHENTICATION ERROR” or “ALREADY AUTHENTICATED (NORMAL)” does not exist in the distributed software information because the license authentication has not been carried out.

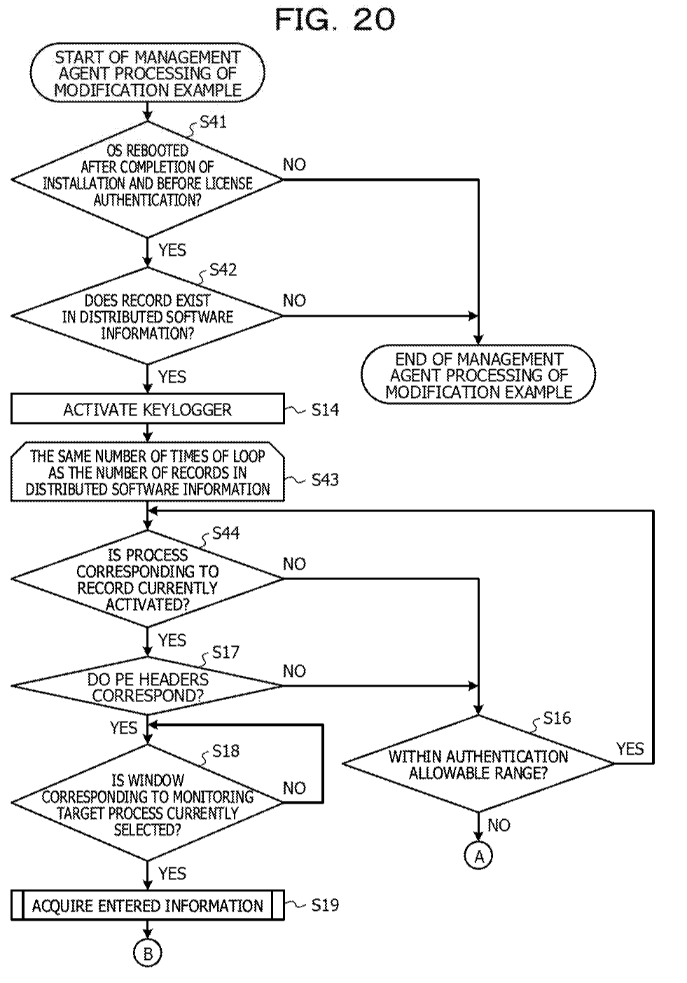

In some cases, plural records in which the distribution result represents “NOT YET AUTHENTICATED (ALREADY INSTALLED)” exist in the distributed software information. As illustrated in the flowchart of FIG. 20, the same number of times of loop processing as the number of records in the distributed software information is executed (step S43).

The activation state determining unit 13 determines whether or not the process (monitoring target process) corresponding to the record in which the distribution result represents “NOT YET AUTHENTICATED (ALREADY INSTALLED)” in the distributed software information is currently activated (step S44).

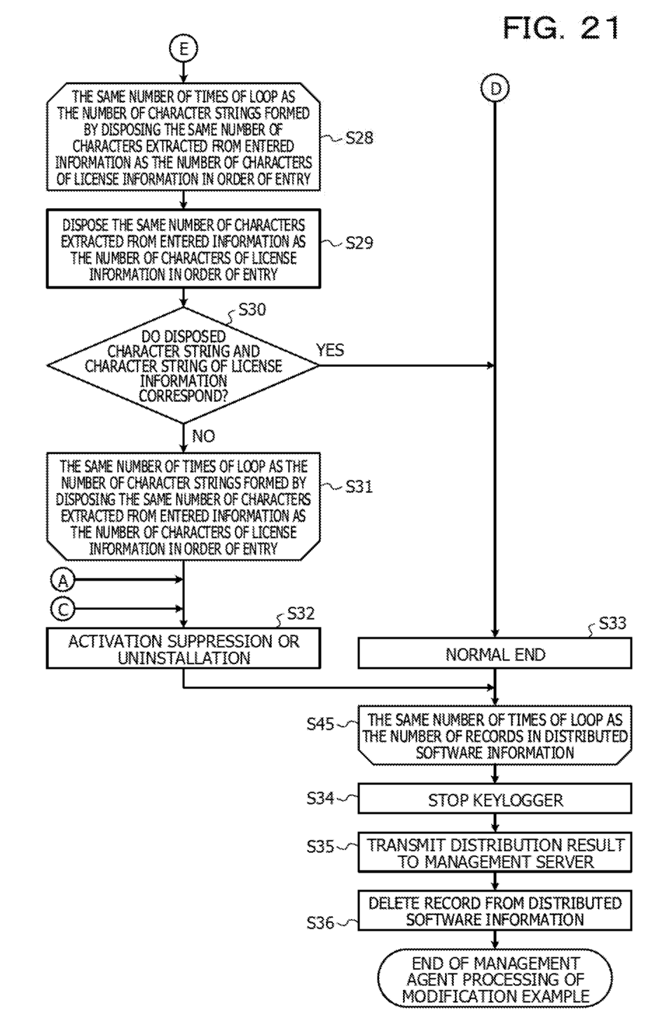

The processing of the step S16 to the step S33 is the same as the respective kinds of processing in FIG. 11, FIG. 12, FIG. 13, and FIG. 17 and therefore description thereof is omitted. As illustrated in the example of FIG. 21, the loop processing to the step S32 or the step S33 (loop processing corresponding to the step S43) is executed (step S45).

The respective kinds of processing of the step S34 to the step S36 are the same as the example of FIG. 17 and therefore description thereof is omitted.

In the flowchart of FIG. 20 and FIG. 21, the same number of times of loop processing as the number of records in the distributed software information is executed. However, the keyloggers 15 according to the number of records in the distributed software information may be activated.

For example, if the number of records in the distributed software information is two, two keyloggers 15 may be activated. In this case, the two keyloggers 15 deem the respective target process names corresponding to software IDs in the monitoring information as the monitoring target processes.

Therefore, in the modification example, the same processing as the above-described embodiment is executed even when the OS of the client terminal 3 is rebooted after the software as the target of license authentication is installed on the client terminal 3 and before the license authentication is carried out. Thus, the load of the license authentication may become low.

<One Example of Hardware Configuration of Client Terminal>

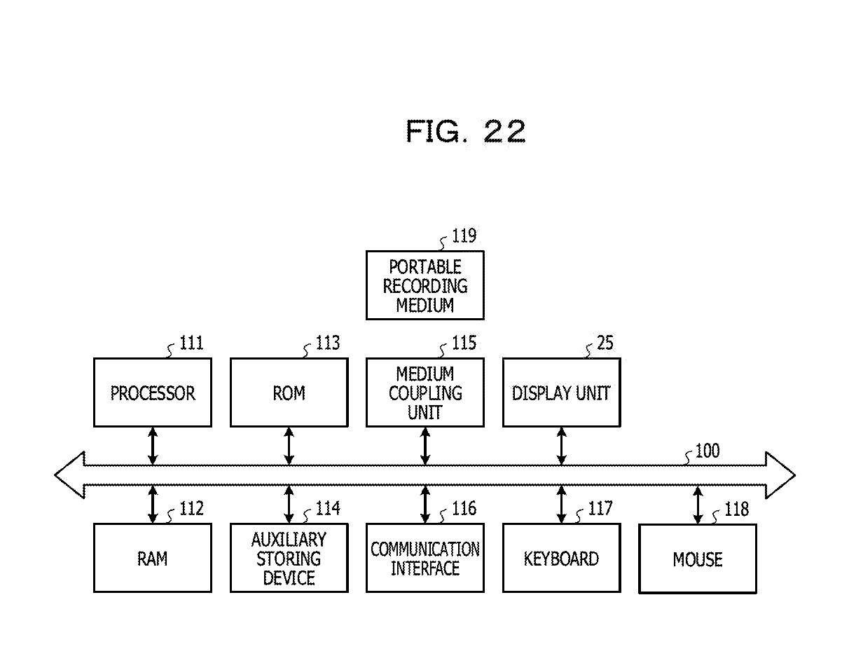

Next, one example of the hardware configuration of the client terminal 3 will be described with reference to an example of FIG. 22. As illustrated in the example of FIG. 22, a processor 111, a RAM 112, a read only memory (ROM) 113, an auxiliary storing device 114, a medium coupling unit 115, and a communication interface 116 are coupled to a bus 100. Furthermore, a keyboard 117, a mouse 118, and the display 25 are coupled to this bus 100.

The processor 111 executes a program loaded in the RAM 112. As the program to be executed, an authentication program that executes processing in the embodiment may be applied.

The ROM 113 is a nonvolatile storing device that stores the program to be loaded in the RAM 112. The auxiliary storing device 114 is a storing device that stores various pieces of information. For example, a hard disk drive, a semiconductor memory, or the like may be applied to the auxiliary storing device 114. The medium coupling unit 115 is provided to be capable of being coupled to a portable recording medium 119.

As the portable recording medium 119, a portable memory (semiconductor memory or the like) or an optical disc (for example, compact disc (CD) or digital versatile disc (DVD)) may be applied. The authentication program that executes processing of the embodiment may be recorded in this portable recording medium 119.

In the client terminal 3, the terminal storing unit 23 may be implemented by the RAM 112, the auxiliary storing device 114, and so forth. The first communication unit 21 may be implemented by the communication interface 116.

The management agent 10 and the display control unit 22 may be implemented through execution of the given authentication program by the processor 111. The entry device 24 may be implemented by the keyboard 117, the mouse 118, and so forth.

The RAM 112, the ROM 113, the auxiliary storing device 114, and the portable recording medium 119 are each one example of a computer-readable, tangible storage medium. These tangible storage media are not a temporary medium like a signal carrier.

<Others>

The present embodiment is not limited to the embodiment described above and may take various configurations or embodiments without departing from the gist of the present embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method executed by a computer, the method comprising:
accepting specifying of target software as a target of authentication of a license;
determining whether a monitoring target process associated with the target software is activated based on information managing a plurality of activated processes, the monitoring target process being a process that executes installation of the target software;
determining whether a specific display area corresponding to the monitoring target process is selected based on a selection state of each of a plurality of display areas each corresponding to each of the plurality of activated processes when it is determined that the monitoring target process is activated;
acquiring entered information entered by an entry device when it is determined that the specific display area corresponding to the monitoring target process is selected;
carrying out matching between the entered information and license information that is acquired from a memory and is associated with the target software; and
carrying out control according to a result of the matching.

2. The method according to claim 1, wherein the entered information is entered from the entry device in a time period from start of selection of the specific display area till a release of the selection.

3. The method according to claim 1, wherein the entered information is stored in a given storage area in the memory for a time period after being entered from the entry device and the entered information is acquired from the given storage area when it is determined that the display area is selected.

4. The method according to claim 1, wherein
the information managing the plurality of activated processes includes a plurality of identification information corresponding to each of the plurality of activated processes, and
the monitoring target process includes first identification information and second identification information.

5. The method according to claim 4, further comprising:
determining whether the monitoring target process is activated based on the plurality of identification information, the first identification information, and the second identification information.

6. The method according to claim 5, further comprising:
carrying out, when the computer is rebooted, another matching of another license information of another target software based on another monitoring target process corresponding to the another target software,
wherein the another software is associated with software with regard to which the matching of the license information has not been carried out.

7. The method according to claim 1, further comprising:
acquiring the license information associated with the target software and a pattern of the license information based on correspondence information between the license information of the target software and the pattern of the license information; and
determining that the matching fails when the entered information does not include the pattern.

8. The method according to claim 7, further comprising:
determining that the matching succeeds when the entered information includes the pattern and when a character string of the entered information is included in a character string of the license information.

9. The method according to claim 8, further comprising:
determining that the matching succeeds when the entered information includes the pattern and when a character string in which a plurality of characters extracted from the character string of the entered information according to order of sequence in the character string of the entered information are sequentially disposed corresponds with the character string of the license information.

10. A non-transitory computer-readable storage medium storing a program that causes a computer to execute a process, the process comprising:
accepting specifying of target software as a target of authentication of a license;
determining whether a monitoring target process associated with the target software is activated based on information managing a plurality of activated processes, the monitoring target process being a process that executes installation of the target software;
determining whether a specific display area corresponding to the monitoring target process is selected based on a selection state of each of a plurality of display areas each corresponding to each of the plurality of activated processes when it is determined that the monitoring target process is activated;
acquiring entered information entered by an entry device when it is determined that the specific display area corresponding to the monitoring target process is selected;
carrying out matching between the entered information and license information that is acquired from a memory and is associated with the target software; and
carrying out control according to a result of the matching.

11. A device comprising:
a memory; and
a processor coupled to the memory and configured to:
accept specifying of target software as a target of authentication of a license,
determine whether a monitoring target process associated with the target software is activated based on information managing a plurality of activated processes, the monitoring target process being a process that executes installation of the target software,
determine whether a specific display area corresponding to the monitoring target process is selected based on a selection state of each of a plurality of display areas each corresponding to each of the plurality of activated processes when it is determined that the monitoring target process is activated,
acquire entered information entered by an entry device when it is determined that the specific display area corresponding to the monitoring target process is selected,
carry out matching between the entered information and license information that is acquired from the memory and is associated with the target software, and
carry out control according to a result of the matching.

12. The device according to claim 11, wherein the entered information is entered from the entry device in a time period from start of selection of the specific display area till a release of the selection.

13. The device according to claim 11, wherein the entered information is stored in a given storage area in the memory for a time period after being entered from the entry device and the entered information is acquired from the given storage area when it is determined that the display area is selected.

14. The device according to claim 11, wherein
the information managing the plurality of activated processes includes a plurality of identification information corresponding to each of the plurality of activated processes, and
the monitoring target process includes first identification information and second identification information.

15. The device according to claim 14, wherein the processor is configured to determine whether the monitoring target process is activated based on the plurality of identification information, the first identification information, and the second identification information.

16. The device according to claim 15, wherein
the processor is configured to carry out, when the computer is rebooted, another matching of another license information of another target software based on another monitoring target process corresponding to the another target software, and
the another software is associated with software with regard to which the matching of the license information has not been carried out.

17. The device according to claim 11, wherein the processor is configured to:
acquire the license information associated with the target software and a pattern of the license information based on correspondence information between the license information of the target software and the pattern of the license information, and
determine that the matching fails when the entered information does not include the pattern.

18. The device according to claim 17, wherein the processor is configured to determine that the matching succeeds when the entered information includes the pattern and when a character string of the entered information is included in a character string of the license information.

19. The device according to claim 18, wherein the processor is configured to determine that the matching succeeds when the entered information includes the pattern and when a character string in which a plurality of characters extracted from the character string of the entered information according to order of sequence in the character string of the entered information are sequentially disposed corresponds with the character string of the license information.
